(19) United States
(12) Patent Application Publication
(10) Pub. No.: US 2014/0113651 A1
(43) Pub. Date: Apr. 24, 2014

(54) SAFETY REPORTING AND NOTIFICATION SERVICE WITH ENHANCED PRIVACY

(71) Applicant: SNUGNOTE, LLC, Los Angeles, CA (US)

(72) Inventor: Joshua D. Lovison, Los Angeles, CA (US)

(73) Assignee: SNUGNOTE, LLC, Los Angeles, CA (US)

(21) Appl. No.: 13/658,656

(22) Filed: Oct. 23, 2012

(51) Int. Cl. H04W 24/00

(52) U.S. Cl. 455/456.1

(57) ABSTRACT

A personal tracking and notification system includes a personal communication device for a first user being tracked for inputting and transmitting personal safety tracking information and check-in information to a network server. The server provides a check-in notification to a personal communication device of a second user indicating whether or not the check-in information was received from the first user, whether or not check-in information was received from the first user before expiration of a check-in time period, such as at a scheduled time.

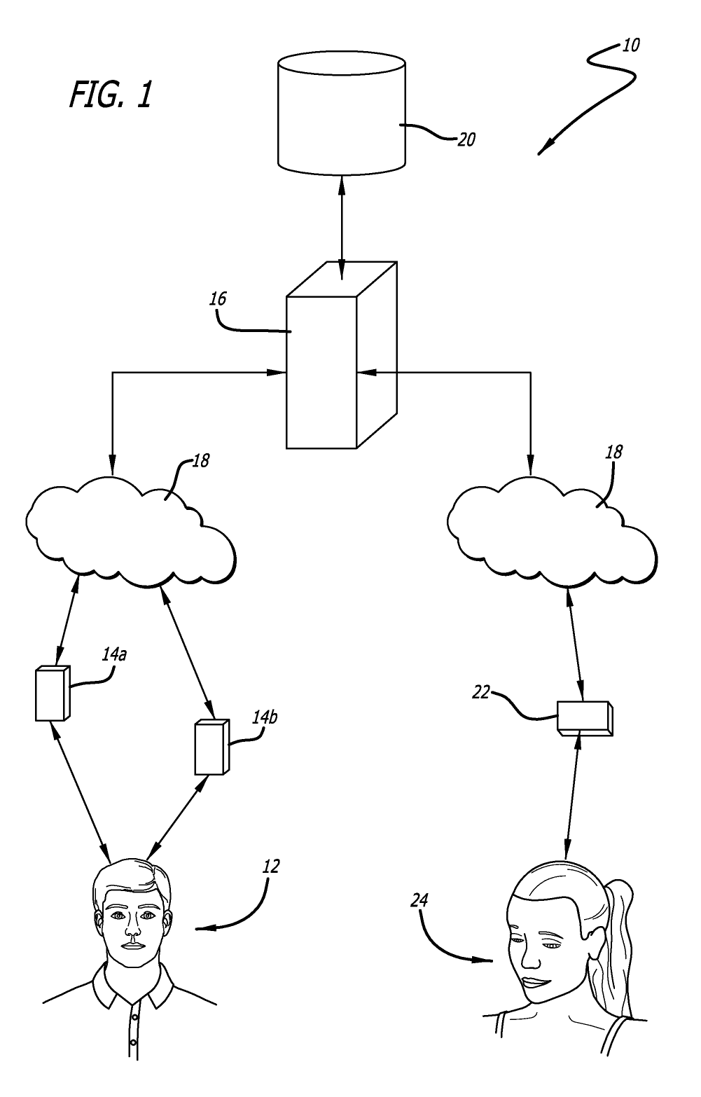

### BACKGROUND OF THE INVENTION

The present invention relates generally to a safety reporting and notification system and method for use with personal communication devices that can be connected through the Internet with a network server, such as a server computer, to monitor personal safety of individuals. More particularly, the present invention relates to a system and method for setting a time period or time frame for one or more first users to check in to verify personal safety, and providing a check-in notification to one or more second users indicating whether or not the check-in information was received from the one or more first users.

Services for tracking children are known that rely on software installed on a child's personal computing device to report to a parent information on locations, Internet use, and communications of the child. However, these services typically provide far more information than most of the children would like to have passed on to a parent, and independent adults are typically not willing to use tracking services that are so invasive of a person's privacy. It is also a trivial matter to bypass such tracking of such services by leaving the personal computing device at one location while going to another, by using another device for messaging and Internet use, or the like. As such, the effectiveness of such services decreases if the software is known to the person being monitored. It is also illegal in all U.S. States to monitor an adult in this manner without their knowledge and consent.

In addition, simply using a person's location to determine their safety is prone to errors, since for example, a location alert that a person is at a normally safe location at a normally safe time does not necessarily indicate that the person is actually safe, for one reason or another, so that a positive affirmation of safety by the person being monitored is a much more accurate representation.

Services for tracking personal safety are also known that set alerts or alarms in specific circumstances, such as when a person is walking down a deserted alley or going on a blind date, for example. However, many of these services integrate their offerings into local law enforcement systems to enable solutions such as “Silent 911”, actively providing GPS coordinates to law enforcement emergency response, or actively monitoring user data for anomalies and submitting law enforcement alerts on the user's behalf. Such integration of technologies is costly, limits availability to certain geographical areas, and results in increased legal responsibility by third parties. In addition, these services for specific circumstances are typically only as effective as their frequency of use. Statistically, people are more likely to enter harm's way during their normal daily activities than in special circumstances. For example, approximately 70% of sexual assaults are commonly perpetrated by someone known to the victim, and approximately 70% of auto accidents typically occur within 10 miles of a driver's home. Safety monitoring services for specific circumstances also usually depend on the user to determine what may be unsafe circumstances, so that they do not account for unexpected circumstances that can compromise safety. In addition, active alert systems are known to generate false positives, which can lead to a high cost of use, and can consequently lead to a frequency of usage of such services far below optimum for ensuring safety.

A variety of personal safety tracking systems also are known that require some form of user check-in as a basis for providing notifications, alerts, and the like, typically providing a notification only when checking in has not occurred as scheduled or within a given time period. For example, one conventional check-in service for anticipating potentially dangerous situations is known in which a portable device such as a cell phone is carried by a user to provide a scheduled communication with a remote monitoring center, which if not received, results in a dispatch operator or computer calling to remind the user, and the forwarding of GPS coordinates of the user to an emergency service, as well as alerting of designated individuals if there is no response to the reminder call.

Another similar subscription based network for tracking users is also known that permits users to supply information such as time of departure, location, and estimated time of arrival, in advance of planned events. Failure to confirm arrival at the event or return from the event within a prescribed time period also alerts designated emergency contacts. Another similar service allows a user to define a security period, indicate termination of the security period, and communicate information concerning the user and the user's location to a security service if the security period is not terminated by the user. Another similar service utilizes time stamping of a user's check-in messages, and can transmit personal safety information if a user's check-in message is not timely received.

It would be desirable to provide a system and method for tracking one or more first users and providing a report to one or more second users, such as an interested third party who may be a subscriber, for example, on a regular basis or at a scheduled time indicating whether or not check-in information was received from the one or more first users. It is desirable that such a report be provided in this manner, for the peace of mind of the one or more second users, regardless of whether or not the one or more first users checked in, or some other conditional event. It is also desirable to protect privacy of users, so that the only information to be sent to the one or more second users should be a Boolean value (i.e., true/false) as to whether or not the one or more first users checked in before a check-in cutoff time.

It is also desirable that added security should not be proportional to added costs, and that the responsibility for alerting law enforcement in cases of anomalous data should be outsourced to one or more second users, such as an interested third party or a loved one, for example. While such one or more second users should only receive a Boolean indication of whether or not the one or more first users checked in before a cutoff in order to protect the privacy of the users being tracked, it would also be desirable that additional information from the one or more first users such as location, photos, intended plans, and audio or video recordings and the like could be received, stored in confidence, and made available, if necessary, in order to assist law enforcement.

It is also desirable that such a system and method for tracking one or more first users and providing a report to one or more second users should depend upon, encourage and enforce regularity of use, to offer improved protection of users for day-to-day common events. The present invention meets these and other needs.

### SUMMARY OF THE INVENTION

Briefly and in general terms, the present invention provides for a system and method for setting a time period or time frame for one or more first users to check in to verify personal safety, and providing a check-in notification to one or more second users indicating whether or not check-in information was received from the one or more first users.

The invention addresses a previously unaddressed desire for adults to know that other adults are safe. This need has not yet been addressed, because first, accessibility of user technology was not such that individuals could have a computing device with them at all times, which thanks to the mobile phone, is now possible, and secondly, no solution has yet been presented that appropriately balanced an adult's wishes for autonomy and privacy against a desire of adults to know that other adults are safe.

The use of a cutoff time circumvents an issue raised by an immediate response (such as from a text message saying “I'm Safe” or another equivalent service) that betrays timestamp information due to the immediate nature of the response, since the use of a cutoff time allows for plausible deniability, and creates a system whereby the possible exposure of the privacy of one or more first users (Group A) to other one or more second users (Group B) becomes so negligible as to be a non-issue. Since Group B users ideally really only care about the knowledge that Group A users are safe, this is a compromise that fits the needs of both groups, a balance that heretofore has not been provided by conventional personal safety tracking systems.

The present invention allows for additional data to be provided concerning the safety of Group A users, and allows for monitoring of the safety of such Group A users by one or more interested third parties, such as a parent or other loved one, for example, and permits a level of safety approaching that of active solutions for specific circumstances, while remaining completely passive, and as a result, incurs little additional cost.

The present invention also depends on and enforces regularity of use. In this respect, the present invention offers far better protection for the “day-to-day” safety of those users to be tracked, particularly for unexpected situations.

The present invention accordingly provides for a personal tracking and notification system, including one or more first personal communication devices for one or more first users to be tracked, a network server, such as a server computer, configured to be connected to the one or more first personal communication devices to receive the personal safety tracking information, and one or more second personal communication devices for one or more second users to be notified. The one or more first personal communication devices preferably are configured to allow the one or more first users to input personal safety tracking information of the one or more first users, to allow the one or more first users to input check-in information verifying personal safety of the one or more first users, and to transmit the personal safety tracking information and the check-in information. The network server is configured to receive the check-in information from the one or more first users, and to provide a check-in notification indicating whether or not the check-in information was received from the one or more first users, and the one or more second personal communication devices are configured to be connected with the network server to receive the check-in notification indicating whether or not the check-in information was received from the one or more first users.

In a presently preferred aspect, the network server optionally also may be configured to transmit an identification of the one or more first personal communication devices, and optionally may be configured to transmit location information identifying a location of the one or more first personal communication devices. In another presently preferred aspect, the personal safety tracking information includes a check-in time period cutoff for the one or more first users to input the check-in information, and may optionally include information concerning an event. In another presently preferred aspect, the one or more first personal communication devices are configured to be connected with the network server via the Internet. In another presently preferred aspect, the one or more first personal communication devices comprises a personal computing device, such as a personal computer, tablet computer, smartphone or mobile telephone, for example.

In another presently preferred aspect, the network server is configured to provide the check-in notification at some time when or after the check-in time period cutoff expires, and the network server is preferably configured to provide the check-in notification whether or not the check-in information was received from the one or more first users before expiration of the check-in time period. In another presently preferred aspect, the network server is configured to provide the check-in notification at a scheduled time. In another presently preferred aspect, the network server may be configured to add a time stamp to the check-in information indicating a time the check-in information was received from the one or more first personal communication devices, and may be configured to add information to the check-in information indicating a manner in which the check-in information was received from the one or more first personal communication devices. In another presently preferred aspect, a storage device is connected to the network server and is configured to store the personal safety tracking information of the one or more first users. In another presently preferred aspect, the one or more second personal communication devices may be a personal computing device, such as a personal computer, tablet computer, smartphone or a mobile telephone, for example, and the personal computing device may be configured to be connected with the network server via the Internet.

The present invention also provides for a method for tracking one or more first users and providing a check-in notification indicating whether or not check-in information of the one or more first users was received to one or more second users. The method involves the steps of inputting personal safety tracking information of one or more first users, and providing an opportunity for the one or more first users to input check-in information verifying personal safety of the one or more first users. The personal safety tracking information and any check-in information of the one or more first users are stored, and a check-in notification is provided indicating whether or not the check-in information was received. In a presently preferred aspect, the method may also include the steps of transmitting the personal safety tracking information, and transmitting the check-in information. In another presently preferred aspect, the method may also include the steps of receiving the personal safety tracking information, and receiving the check-in information from the one or more first users. In another presently preferred aspect, the step of transmitting the personal safety tracking information may include transmitting an identification of one or more first personal communication devices of the one or more first users, and may also include transmitting location information identifying a location of the one or more first personal communication devices.

In another presently preferred aspect, the personal safety tracking information includes a check-in time period cutoff for the one or more first users to input the check-in information, and the personal safety tracking information optionally may include information concerning a planned event and time frame. In another presently preferred aspect, the step of providing a check-in notification preferably includes generating the check-in notification after the check-in time period cutoff expires, whether or not the check-in information was received before expiration of the check-in time period. In another presently preferred aspect, the check-in information includes a time stamp indicating a time the check-in information was received, and may include information about a manner in which the check-in information was received.

These and other features and advantages of the present invention will become more apparent from the following detailed description of the preferred embodiments in conjunction with the accompanying drawing, which illustrates, by way of example, the operation of the invention.

### BRIEF DESCRIPTION OF THE DRAWINGS

The FIGURE is a schematic diagram illustrating the system and method for providing safety reporting and notification according to the present invention.

### DETAILED DESCRIPTION OF THE PREFERRED EMBODIMENTS

While conventional services for tracking minors utilizing software installed on a personal computing device to report information to a parent, such as locations, Internet use, and communications, for example, can be adequate while a child is a minor, such conventional services are generally inadequate concerning matters of privacy and accuracy of information for tracking of adults.

The present invention accordingly provides for a personal tracking and notification system and method for use with devices such as personal computers, tablet computers, smartphones, mobile telephones and the like that can be connected via the Internet with a network server to keep track of the personal safety of individuals. The system sets or optionally allows the person to be tracked to set a time period to check in to verify personal safety, and allow the person to request that the system notify someone such as a parent, a minder, or next of kin, for example, who would typically be a subscriber, whether checking in has occurred or not.

The system optionally also may allow a person being tracked to notify the tracking and notification server site of an event or situation, such as being home alone during a visit from a repairman, or meeting a blind date, for example, and to provide tracking and other relevant information. With the permission and approval of the person to be tracked, anyone in the capacity of a minder or next of kin, such as a parent, for example, can become a subscriber to a report that can be sent out on a regular or scheduled basis to provide a notification as to whether or not checking in by a predetermined check-in or cutoff time has occurred. If checking in has occurred, a time stamp indicating time, manner, and if possible, location information, is recorded for each checking in for archival purposes, although the time stamp and location information is maintained in confidence. The tracking and other relevant information provided by the person being tracked is maintained in confidence. Missing persons reports on Department of Justice sites and national indexes, will be actively monitored to cross-reference to users. If a match is found between the subject of a missing persons report and a user of the service, information logged in with the service will be flagged for review as to whether that information should be made available to the proper authorities, so that such information optionally may be sent on to an officer or other contact indicated in the report, or local law enforcement in charge of an investigation, in a “missing persons” or “disappearance under suspicious circumstances” situation.

The kinds of personal tracking information that can be provided by the person being tracked can include device specific information of a personal computing device of the person being tracked, such as hardware model, operating system version, unique device identifiers, and mobile network information including phone number; log information, including IP address; device event information location information, including current local time of the person being tracked; contact information for telephone contacts; and photographs taken by the personal computing device; and information from third parties.

For close knit family ties (such as parent/child, grandparent/grandchild), regular reassurance that the member of the younger generation is safe can be an important, highly marketable service. Likewise, for older generations, such as single adults or elderly persons, for example, knowledge that someone else is following their safety and would be aware should anything happen also can be significant, and marketable, though possibly to a slightly lesser degree than for the younger generation.

The system and method of the invention advantageously provide a report on a regular or scheduled basis to an interested third party giving a notification as to whether checking in has occurred or not. A report is sent out for a user (Group A) regardless of whether they checked in or not—there is no “trigger” aspect; and to protect user privacy, the only information that is sent on to another subscribed user (Group B) is the Boolean value (i.e. true/false) as to whether or not the user (Group A) checked in before the cutoff.

In developing the solution of the present invention, the added security of these measures is designed not to be proportional to the added costs. The present invention places the responsibility for alerting law enforcement on second users to be notified, such as interested third parties or loved ones of the first users being tracked, for example. And while the second users to be notified can only receive the Boolean value of whether another user checked in before a cutoff, the present invention can be configured to receive additional information up to and including location, photos, intended plans, and audio or video recordings. This additional data can be stored in a forensically sound manner in order to assist law enforcement if necessary. These two features (additional data and loved ones monitoring users) enable a level of safety approaching that of active monitoring solutions while remaining completely passive, and as a result, incurring little additional cost.

Referring to the drawing, which is provided by way of example, and not by way of limitation, the present invention provides for a personal tracking and notification system 10 for one or more first users 12 to be tracked, such as one or members of a subscribee user (group A), and one or more first personal communication devices 14a,b of the one or more first users, which is preferably a personal computing device, typically such as a personal computer, tablet computer, smartphone, mobile telephone, or the like, for example. The one or more first personal communication devices are configured to be connected with a network server 16, such as one or more server computers loaded with appropriate software, for example, through a network such as via the Internet 18, for example, although other networks such as local networks or cellular networks may also be suitable. The network server is preferably connected to a persistent data storage device (i.e., a database) 20, which may be included in the network server, for example, for storing the personal safety tracking information of the one or more first users.

The one or more first personal communication devices are configured to allow the one or more first users to input personal safety tracking information of the one or more first users, to allow the one or more first users to input check-in information to verify personal safety of the one or more first users, and to transmit the personal safety tracking information and the check-in information to the network server. In a presently preferred aspect, the one or more first personal communication devices are configured to transmit an identification of the one or more first personal communication devices, and to transmit location information identifying a location of the one or more first personal communication devices to the network server. The personal safety tracking information also preferably includes a check-in time period or timestamp cutoff that may be set as a predetermined check-in time period or timestamp cutoff, or that alternatively may be set by the one or more first users, for the one or more first users to input the check-in information, and in another aspect optionally the one or more first users can identify an event the one or more first users plans to attend.

The network server is configured to be connected to the one or more first personal communication devices to receive the personal safety tracking information, to receive the check-in information from the one or more first users, and to provide a check-in notification indicating whether or not the check-in information was received from the one or more first users. In a presently preferred aspect, the network server is configured to provide the check-in notification after the check-in time period or timestamp cutoff expires, preferably whether or not the check-in information was received from the one or more first users before expiration of the check-in time period.

The network server is configured to provide the check-in notification to one or more second personal communication devices 22 configured to be connected with the network server, such as via the Internet, for example, to provide check-in notification information to one or more second users 24, such as one or members of a subscribing user (group B) to be notified at a scheduled time, such as at regularly scheduled recurring times, or by the end of a time frame determined by the system or optionally identified by the one or more first users, for example. The check-in information preferably includes a time stamp, which can be provided by the at least one personal communication device or added by the network server, for example, indicating a time the check-in information was received from the one or more first personal communication devices. The check-in notification information also preferably includes information as to a manner in which the check-in information was received from the one or more first personal communication devices. The check-in notification information also preferably includes location information concerning a location of the one or more first personal communication devices, which can be provided by the one or more first personal communication devices, for example. The one or more second personal communication devices are configured to receive the check-in notification indicating whether or not the check-in information was received from the one or more first users. The one or more second personal communication devices are preferably a personal computing device, such as a personal computer, tablet computer, smartphone, mobile telephone, or the like, for example.

The safety notification and reporting service system of the invention generally relies on a time-based cutoff. If the one or more first users being tracked affirm that they are safe prior to the cutoff, they are counted as safe. If they do not, their safety status is considered unknown. A report is sent out after the cutoff with the check-in status of the one or more first users (Group A) as having checked in or not to other the one or more second users (Group B) that have subscribed to reports for one or more first users (Group A), respectively.

The process for the system is as follows:

1. A subscription relationship with a first user from Group A, and preferably also with a second user from Group B (i.e. subscribee and subscriber, respectively) is created and stored on the server.

2. A cutoff time is set (either by interaction with a first user being tracked from Group A, the subscribee, or by the system, such as by the first user's personal communication device or the network server) for some point in the future. The cutoff time can either be relative to the time zone of the first user from Group A (the subscribee), or absolute. The cutoff time represents the end of a n-long period, where n typically may be between (inclusively) one hour and one week.

3. Before the cutoff occurs, either the first user from Group A affirms their safety, or fails to do so. If the first user does affirm their safety, this affirmation is stored on the server. The first user can create this affirmation by interacting with the server from a first personal computing device, such as through a webpage or an app, for example.

4. After the time of the cutoff has passed the server checks to see if an affirmation of safety has been stored between the time of the cutoff and a time n-hours prior to the cutoff (where n is the number of hour for that cutoff time—i.e. if the cutoff represents a 24-hour period, n=24).

5. The server generates a report for the subscribing second user (Group B) that only states whether the subscribed first user (Group A) had an affirmation of safety as determined in step 4, such as that no other information, such as location or actual time the affirmation was made is included, for example. This report may be an email message, a push notification, or simply a report generated on a website the subscribing second user (Group B) can access, for example.

In another presently preferred aspect, the system and method of the invention optionally can be enhanced to provide reminders to the one or more first users in Group A. In this instance, a notification system that can send a notification to devices for users from Group A is required. For this option, the one or more first users in Group A have notification preferences (either set manually or automatically) stored on the server. These preferences designate times that are either absolute or relative to the user's time-zone, in relation to an upcoming cutoff time. When the one or more reminder times stored in the notification preferences are reached, the server sends a corresponding notification via the notification system to the one or more first users in Group A reminding them of the upcoming cutoff and the need to provide an affirmation of safety. This notification system could be email, a push notification service, or another similar notification technology, for example.

In a further option, the server may continue to send notifications to the one or more first users in Group A if they have not yet provided an affirmation of safety between the time of the first notification and the cutoff. Over time, without a notification service to remind the one or more first users from Group A about the need to affirm their safety, fewer of those users may be expected to proactively interact with the service. With email notifications, over half of users are expected to affirm their safety on a regular basis, and with push notifications to mobile devices, this is expected to increase to over 80% of users affirming their safety on a daily basis.

In another presently preferred aspect of the system and method of the invention, additional data optionally can be collected from the one or more first users of Group A, and stored in a forensically sound manner in order to assist law enforcement on behalf of users. Either at the time of the affirmation of safety, or at other times the user would like, the one or more first users from Group A (even if no subscriber following their safety status exists) can upload additional information to the server, such as location data, a photograph, a video or audio recording, a textual input, and the time the upload occurred, and this data optionally may be encrypted prior to being stored on the server using symmetric-key encryption technology. In another option, the data may be encrypted prior to being stored on the server using public key encryption technology, wherein the private key is not stored on a webserver or on a server containing the permanent storage, but rather on a separate server dedicated to decryption.

In another presently preferred aspect, the server may acquire and process information relating to missing persons reports for various geographies. If a match is found between the subject of a missing persons report and a user of the service, the stored data for that user may be sent to the officer or other contact in the missing persons report.

In another presently preferred aspect, the system and method of the invention optionally can be adapted to receive and respond to cross-user queries. In this instance, a notification system that can send notifications to personal computing devices of users is required. The enhancement is designed to enable quick transfer of information regarding an affirmation of safety. For existing subscription relationships spanning first users in Group A and second users in Group B, the server checks to see if both first and second users in Group A and in Group B have a method on record for delivery of a notification message to a personal computing device (i.e. email or push notification). If so, the server enables a simple communication system between users as determined by Boolean actions.

In one example, a first user from Group A may, proactively, select to notify a second user from Group B that meets the criteria of having a method on record for delivery of a notification message to a personal computing device. If such a selection for proactive notification is made, the server may, without any additional information, immediately (or with a slight delay) send a notification to the intended second user from Group B providing an affirmation of safety for the user from Group A. A second user from Group B optionally at any time may select an inquiry to pose to a first user from Group A about their current safety. If such a selection is made, without any additional input the server may immediately (or with a slight delay) send a notification to the intended user from Group A, and upon receiving such a notification, the corresponding first user from Group A may wish to respond. Based upon only an indication of the desire of the corresponding first user from Group A to respond with an affirmation, and no additional data or input, the server may immediately (or with a slight delay) send a notification to the original user from Group B indicating the affirmation of safety from the Group A user. Conversely, a first user from Group A, such as a child, for example, also can independently, without prompting, send a notification to let a second user from Group B, such as their parent, for example, know they are all right, such as, for example, when flying somewhere, sending a reassuring notification on landing. Such communications may be included selectively in the basic reports for those first users in Group A.

While the technology employed to delivery these notifications is not specific to any one kind of technology, the intent is that the destination device for users from Group A would be a personal computing device carried on their person. The systems and technologies involved also are not specific and can work across technologies currently known or yet to be developed. While the structural relationship between personal devices and a centralized server is a core aspect of the invention, in some instances the “server” could be located on the devices of first users from Group A, and the invention would still be able to operate as described on a per-user basis. It also will be apparent that the system and method of the invention has other potential applications, such as integration with college campus security to proactively investigate users who have not checked in, to potential applications regarding missing persons programs of law enforcement agencies.

It will be apparent from the foregoing that while particular forms of the invention have been illustrated and described, various modifications can be made without departing from the spirit and scope of the invention. Accordingly, it is not intended that the invention be limited, except as by the appended claims.

What is claimed is:

1. A personal tracking and notification system, comprising:
at least one first personal communication device for at least one first user to be tracked, said at least one first personal communication device being configured to allow the at least one first user to input personal safety tracking information of the at least one first user, to allow the at least one first user to input check-in information verifying personal safety of the at least one first user, and to transmit said personal tracking information and said check-in information;
a network server configured to be connected to said at least one first personal communication device to receive said personal safety tracking information, to receive said check-in information from the at least one first user, and to provide a check-in notification indicating whether or not said check-in information was received from the at least one first user; and
at least one second personal communication device for at least one second user to be notified, said at least one second personal communication device being configured to be connected with the network server to receive said check-in notification indicating whether or not said check-in information was received from said at least one first user.

2. The personal tracking and notification system of claim 1, wherein said network server is configured to provide said check-in notification after a check-in time period cutoff expires.

3. The personal tracking and notification system of claim 1, wherein said network server is configured to transmit an identification of said at least one first personal communication device.

4. The personal tracking and notification system of claim 1, wherein said network server is configured to transmit location information identifying a location of said at least one first personal communication device.

5. The personal tracking and notification system of claim 2, wherein the check-in time period cutoff is set by said at least one first user for said at least one first user to input said check-in information.

6. The personal tracking and notification system of claim 2, wherein the check-in time period cutoff is set by at least one second user for said at least one first user to input said check-in information.

7. The personal tracking and notification system of claim 2, wherein the check-in time period cutoff is set by said network server for said at least one first user to input said check-in information.

8. The personal tracking and notification system of claim 1, wherein said personal safety tracking information includes information concerning an event.

9. The personal tracking and notification system of claim 1, wherein said at least one first personal communication device is configured to be connected with said network server via the Internet.

10. The personal tracking and notification system of claim 1, wherein said at least one first personal communication device comprises a personal computing device.

11. The personal tracking and notification system of claim 10, wherein said at least one first personal communication device is selected from the group consisting of a personal computer, tablet computer, smartphone and a mobile telephone.

12. The personal tracking and notification system of claim 2, wherein said network server is configured to provide said check-in notification whether or not said check-in information was received from said at least one first user before expiration of the check-in time period.

13. The personal tracking and notification system of claim 1, wherein said network server is configured to provide said check-in notification at a scheduled time.

14. The personal tracking and notification system of claim 1, wherein said network server is configured to add a time stamp to said check-in information indicating a time said check-in information was received from said at least one first personal communication device.

15. The personal tracking and notification system of claim 1, wherein said network server is configured to add information to said check-in information indicating a manner in which said check-in information was received from said at least one first personal communication device.

16. The personal tracking and notification system of claim 1, further comprising a storage device connected to said network server and configured to store said personal safety tracking information of said at least one first user.

17. The personal tracking and notification system of claim 1, wherein said at least one second personal communication device is configured to be connected with said network server via the Internet.

18. The personal tracking and notification system of claim 1, wherein said at least one second personal communication device comprises a personal computing device.

19. The personal tracking and notification system of claim 18, wherein said at least one second personal communication device is selected from the group consisting of a personal computer, tablet computer, smartphone and a mobile telephone.

20. A method for tracking at least one first user and providing a check-in notification indicating whether or not check-in information of said at least one first user was received to at least one second user, comprising the steps of:
inputting personal safety tracking information of at least one first user;
storing said personal safety tracking information of said at least one first user;
inputting check-in information of said at least one first user verifying personal safety of said at least one first user;
storing said check-in information from the at least one first user; and
providing a check-in notification indicating whether or not said check-in information was received from the at least one first user.

21. The method of claim 20, wherein said network server provides said check-in notification after a check-in time period cutoff for said at least one first user to input said check-in information expires.

22. The method of claim 21, further comprising the step of setting the check-in time period cutoff.

23. The method of claim 20, wherein said personal safety tracking information includes information concerning an event.

24. The method of claim 20, further comprising the steps of:
transmitting said personal safety tracking information; and
transmitting said check-in information.

25. The method of claim 24, further comprising the steps of:
receiving said personal safety tracking information from said at least one first user; and
receiving said check-in information from said at least one first user.

26. The method of claim 24, wherein said step of transmitting said personal safety tracking information comprises transmitting an identification of at least one first personal communication device of said at least one first user.

27. The method of claim 24, wherein said step of transmitting said personal safety tracking information comprises transmitting location information identifying a location of said at least one first personal communication device.

28. The method of claim 21, wherein said step of providing a check-in notification comprises providing said check-in notification whether or not said check-in information was received from said at least one first user before expiration of the check-in time period cutoff.

29. The method of claim 20, wherein said check-in information comprises a time stamp indicating a time said check-in information was received.

30. The method of claim 20, wherein said check-in information comprises a manner in which said check-in information was received.
